(19) United States
(12) Patent Application Publication
(10) Pub. No.: US 2010/0114390 A1
(43) Pub. Date: May 6, 2010

(54) LOAD OPERATION PROFILING AND NOTIFICATION IN A MONITORED ELECTRICAL POWER DISTRIBUTION SYSTEM

(75) Inventors: Thomas S. Stevenson, Victoria (CA); John C. van Gorp, Sidney (CA); Matthew Stanlake, Victoria (CA); Vincent Wruck, Victoria (CA); Jacques Van Campen, Saanichton (CA); Douglas Cope, Filmore, CA (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: SQUARE D COMPANY, Palatine, IL (US)

(21) Appl. No.: 12/265,116

(22) Filed: Nov. 5, 2008

(51) Int. Cl. G06F 17/00

(52) U.S. Cl. 700/292

(57) ABSTRACT

A method of monitoring the operation of a load in an electrical power distribution system comprises selecting a parameter representing operation of the load, determining an expected characteristic of the parameter during normal operation of the load, and comparing measured values of the parameter with the expected characteristic to detect potential abnormal operation of the load.

### FIELD OF THE INVENTION

The present invention relates to load operation profiling and notification in monitored electrical power distribution systems.

### BACKGROUND OF THE INVENTION

One power monitoring system function is to provide notification when a monitored load operates outside expected norms. One common approach is to configure at least one set point to monitor a measurement representing load operation; when measurement values exceed a preset bound, a notification is generated. The set point approach can be used to detect extreme measurement values that are outside the typical operating range of a load, but cannot be used to detect unexpected measurement values that occur within the operating range of the load.

### SUMMARY OF THE INVENTION

In accordance with one embodiment, a method of monitoring the operation of a load in an electrical power distribution system comprises selecting a parameter representing operation of the load, determining an expected characteristic of the parameter during normal operation of the load, and comparing measured values of the parameter with the expected characteristic to detect potential abnormal operation of the load.

In one implementation, the expected characteristic of the parameter is a statistical summary or model of multiple measured values of the parameter during normal operation of the load. For example, the statistical summary or model may comprise amplitudes for different harmonic frequencies from a Fourier analysis of measured values for the load, or a standard deviation from the mean of a set of measured values of the parameter.

In one particular embodiment, the expected characteristic defines expected bounds for variations in the parameter as a function of a second parameter during normal operation of the load. For example, the expected characteristic may be a statistical summary or model of multiple measured values of a first parameter versus a second parameter that is a driver of the normal operation of the load.

The foregoing and additional aspects of the present invention will be apparent to those of ordinary skill in the art in view of the detailed description of various embodiments, which is made with reference to the drawings, a brief description of which is provided next.

### BRIEF DESCRIPTION OF THE DRAWINGS

The invention may best be understood by reference to the following description taken in conjunction with the accompanying drawings, in which:

FIG. 1 is a block diagram of a monitored electrical power distribution system having multiple monitors and multiple loads.

FIG. 2 is a plot of variations in a parameter representing operation of a load or a portion of a load as a function of time, along with predetermined profile bounds for the parameter.

FIG. 3 is a plot of energy consumption of a load or power circuit as a function of the hour of day.

FIG. 4 is a plot of energy consumption of a fan load as a function of whether the fan is on or off.

FIG. 5 is a plot of energy consumption of a load or power circuit as a function of temperature, and including a best-fit line for the plotted data.

FIG. 6 is a graphic illustration of the results of a Fourier analysis of a set of energy consumption data grouped by the status of a fan load.

FIG. 7 is a plot of energy consumption of a packaged rooftop unit as a function of sub-loads within the rooftop unit.

FIG. 8 is a plot of energy consumption of a packaged rooftop unit as a function of temperature.

FIG. 9 is a plot of energy consumption of a power transformer as a function of harmonic frequency for a first portion of a day.

FIG. 10 is a plot of energy consumption of a power transformer as a function of harmonic frequency for a second portion of a day.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

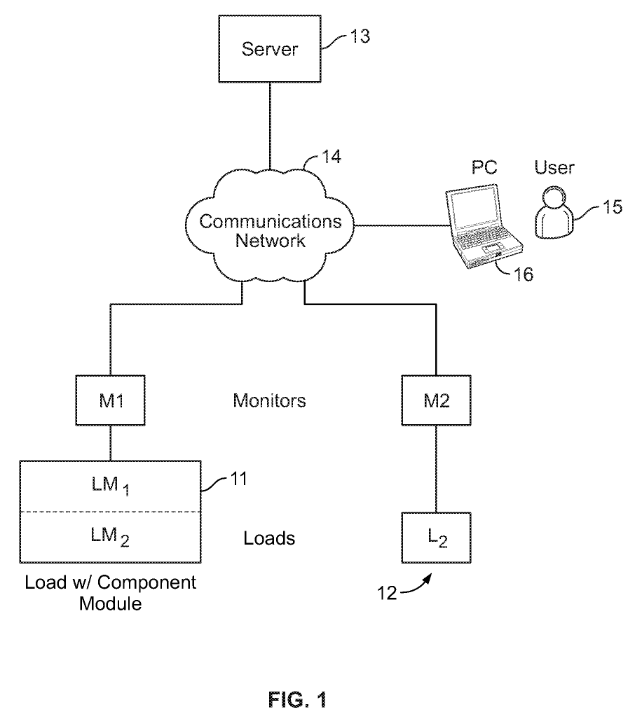

Turning now to the drawings and referring first to FIG. 1, a monitoring system for an electrical power distribution system includes a pair of monitors M1 and M2 that perform measurements of one or more parameters (such as kW or amps) related to attached loads. The monitor M1 is connected to a load 11 that includes two separate load modules LM1 and LM2, such as fans and heating or cooling coils within HVAC equipment, and the monitor M2 is connected to a load 12. The monitors M1 and M2 store the measured information and communicate it to a server 13 via a communications network 14. The server 13 also stores this information and performs load operation profiling, analysis and notification functions. A user 15 may use a personal computer 16 connected to the communications network 14 to perform various functions such as analyzing parameter measurements from the monitors M1 and M2, configuring profiles used in analyzing the measurements made by the monitoring system, and configuring, sending and receiving notifications.

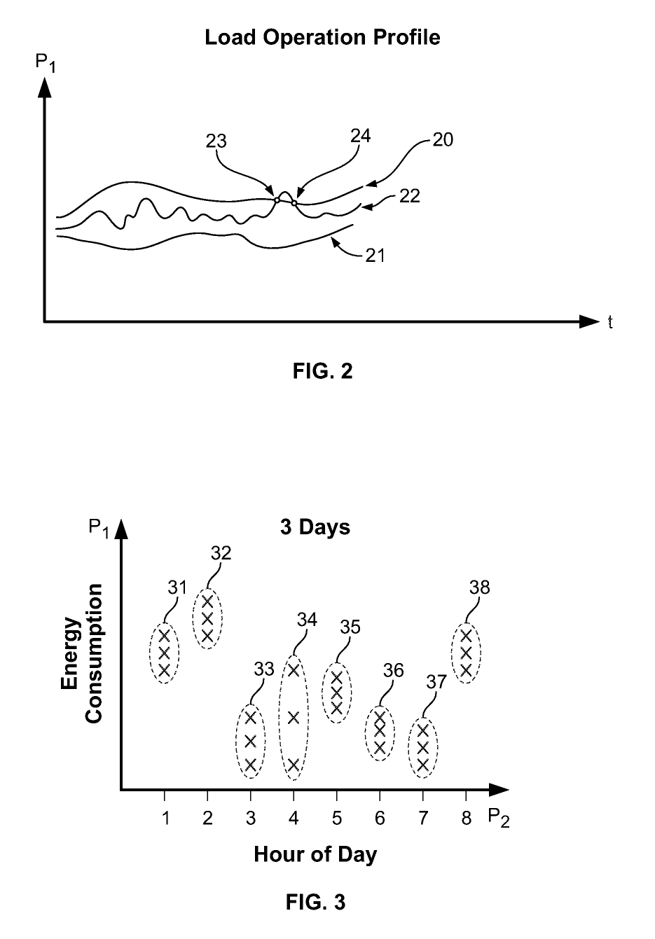

FIG. 2 illustrates a “load operation profile” that describes an expected range of values of a parameter selected to represent the operation of a load or multiple loads on a circuit. A “profile” defines one or more bounds of the expected operation (parameter trend characterization, harmonic characterization, delta change in parameter after event, etc.) of a load in terms of one or more parameters. Profiles can be developed using a number of different, complementary techniques (including regression analysis of a load parameter vs. some “driver” parameter, and profiling of harmonic spectra). This profiling can also be combined with voltage disturbance curves for monitored equipment to assess whether a particular load is offline following a detected disturbance, as described in detail in copending U.S. patent application Ser. No. 12/252,047, entitled “System for Detecting Load Loss Following an Electrical Power Disturbance,” filed Oct. 15, 2008.

In FIG. 2, the area between a pair of upper and lower profile bounds 20 and 21 represent the range of expected values for the amplitude of measured values of a parameter P1 as a function of time t. The parameter P1 is a parameter representing operation of a load or multiple loads on a power circuit. Actual measured values of the parameter P1 are represented by line 22. When measurements of the parameter P1 fall outside the bounds 20 and 21, as illustrated by the portion of the line 22 between points 23 and 24 in FIG. 2, a notification of potential abnormal operation can be generated and sent to preselected recipients or addresses. Thus, the actual values of the magnitude of the parameter P1 can be continually evaluated against the profile bounds 20 and 21 to assess the likelihood of abnormal operation of at least a portion of the monitored load or power circuit. A notification may also be sent when the parameter measurements return to values within the profile bounds, as occurs at point 24 in FIG. 2.

The operation of a load can be profiled and tracked using the following steps:
1. Parameter P1 selected to represent load operation, and parameter P2 (representing some “driver” of load operation) is selected.
2. Collect parameter P1 and parameter P2 values for the operating range of the load.
3. Select and perform analysis of collected parameter P1 and P2 values.
4. Observe analysis results and either: (a) run steps 2 and 3 again; or (b) set load operation profile bounds for notification.
5. Configure notification recipients and conditions.
6. System gathers parameter P1 values and evaluates against configured bounds, generating notifications when parameter P1 values exceed set bounds and notification conditions are met.

The steps above can also be repeated to generate multiple profiles for a load, varying elements such as the parameters, analytical techniques and date range of stored measurements used.

Two examples of load profiling analysis approaches are: (a) the best fit of a parameter P1 vs. parameter P2; and (b) a Fourier transform of parameter P1 (in terms of amplitude and frequency) vs. parameter P2.

The best fit approach is illustrated in FIGS. 3-5. In FIG. 3, the magnitude of a parameter P1 such as energy consumption is plotted for each increment of a second parameter P2 such as the hour of day, for a period of three days (three values for each hour). It can be seen that the parameter P1 values are grouped by parameter P2 increments, as shown by the groups 31-38 in FIG. 3, and a statistical summary of the grouped values can be generated. In FIG. 3, the parameter P1 values are groupe by the hour in the day in which they occur, and a statistical summary (such as the mean and standard deviation) for each group of values can be generated and used to establish load profile bounds. A standard deviation measures how widely spread the values in a data set are. If many data points are close to the mean, then the standard deviation is small and, conversely, if many data points are far from the mean, then the standard deviation is large. If all data values are equal, then the standard deviation is zero. A standard deviation is expressed in the same units as the data.

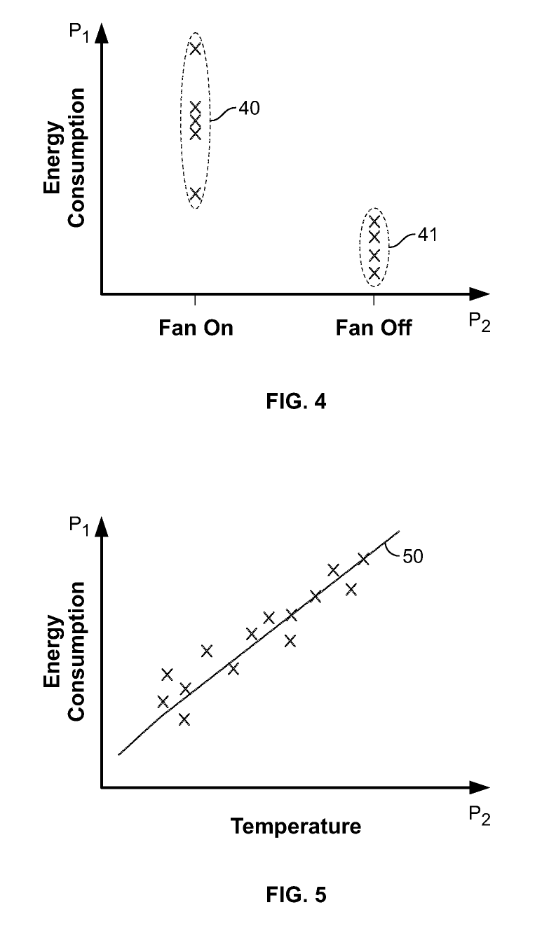

In the example shown in FIG. 4, parameter P2 is the state of a fan (on or off) within a monitored load. Here again, the parameter P1 values can be grouped by parameter P2 values (fan on or off), as shown by the groups 40 and 41 in FIG. 4, and a statistical summary for each group of values can be generated and used to establish load profile bounds.

If there is a more continuous relationship between parameter 1 and parameter P2, a more traditional regression analysis may be performed, as illustrated in FIG. 5. Parameter P1 in FIG. 5 is energy consumption, and parameter P2 is temperature. A best-fit line or curve 50 can be determined and used to develop a load operation profile. This best-fit line 50 may be accompanied by other statistical summary information (such as a confidence interval) which can be used to establish load profile bounds.

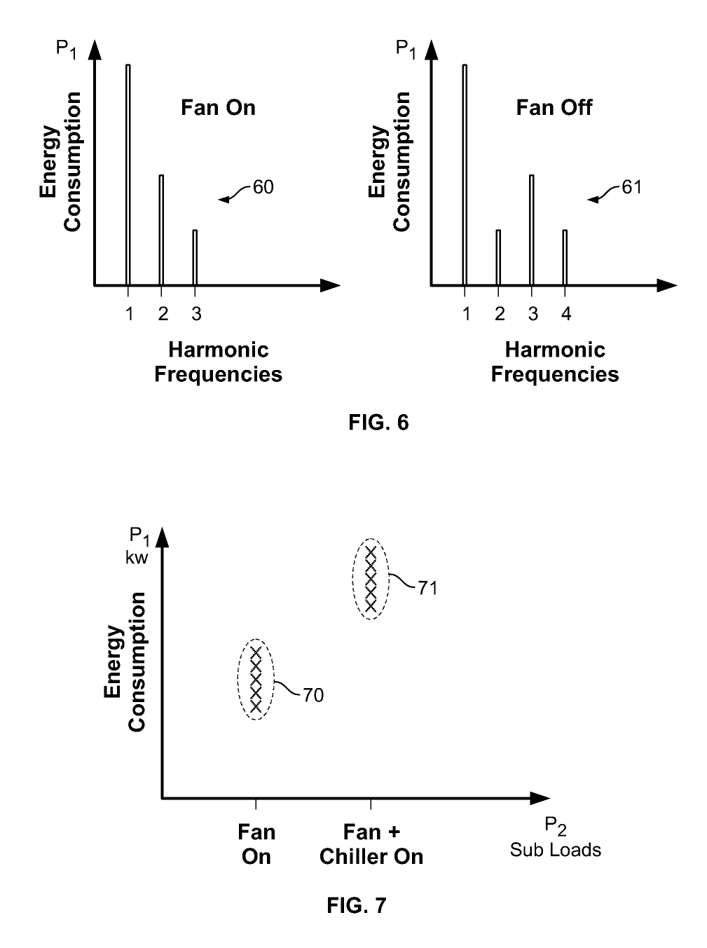

The Fourier transform approach is illustrated by FIG. 6 for a Fourier analysis of parameter P1, grouped by values of parameter P2. In the example in FIG. 6, parameter P1 values (energy consumption) are organized by values of parameter P2 (the status of a fan), and a Fourier analysis is used to generate amplitude values within different harmonic frequency “bins.” A statistical analysis of amplitude values within each harmonic frequency bin can be used to develop the two illustrated harmonic spectrum profiles 60 and 61 for the two different states of the fan.

The load profiling approaches described above generate an “expected” range of values for a parameter selected to represent load operation, typically expressed in statistical terms such as mean, standard deviation and/or confidence interval. Load profile bounds can be based on selected statistical parameter values, and notifications generated when load parameter values exceed these bounds. As an example, if parameter P1 values are collected over the operating range of a load and are grouped by parameter P2 values, as described above, standard deviations can be calculated for each parameter P1 grouping, and load profile bounds set at two standard deviations for each grouping.

One or more of the approaches described above can be applied to develop load operation profiles that may be evaluated together to provide a comprehensive view of expected load operation. Two examples are illustrated in FIGS. 7-10.

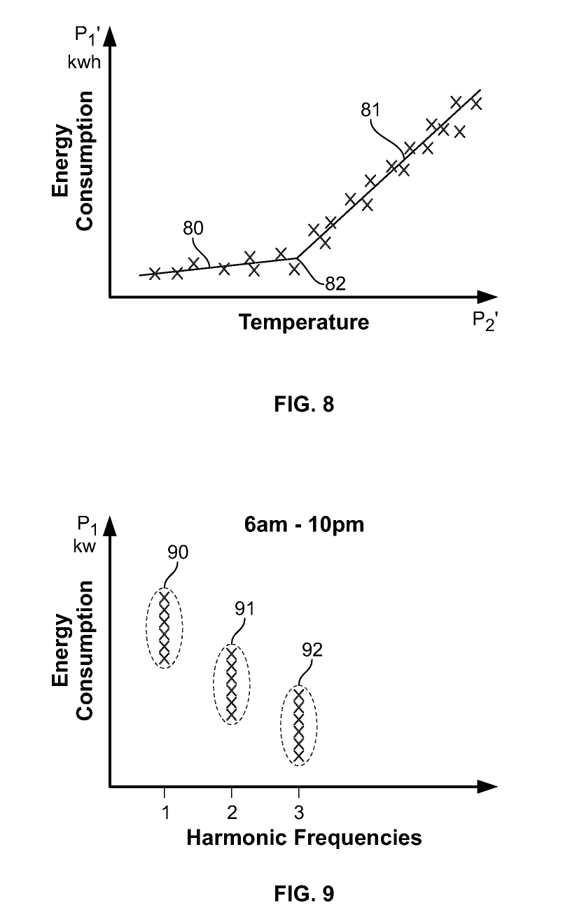

In FIGS. 7 and 8, a packaged rooftop unit (RTU) example is illustrated by two load operation profiles. FIG. 7 profiles kW values (parameter P1) vs. the on/off status of RTU load modules (parameter P2, e.g., fan, fan plus chiller), reflecting the fact that, when energized, the RTU either (a) turns on a fan, or (b) turns on both the fan and a chiller. The kW values fall within tight groups, as shown by the groups 70 and 71 in FIG. 7, and expected load operation bounds for these groups can be described by statistical summary parameters such as mean and standard deviation. If measured kW values fall outside these groups, one or more of the load modules may not be operating as expected.

FIG. 8 profiles kWh values (parameter P′1) vs. ambient temperature (parameter P′2), with a regression analysis generating two piecewise linear best-fit lines 100 and 101. FIG. 8 indicates that the RTU consumes more energy as the ambient temperature increases, with a greater rate of consumption after the “breakpoint” 82 formed by the junction of the two linear best-fit lines 80 and 81. One or more statistical summary parameters (such as a confidence interval) may be used to establish expected load operation bounds around both linear best-fit lines.

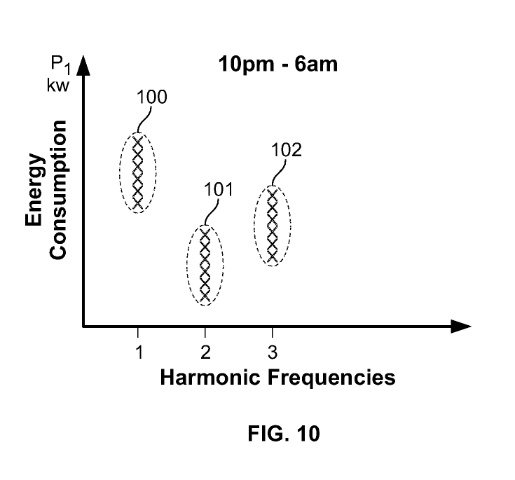

In FIGS. 9 and 10, a power transformer example is illustrated by two load operation profiles. In this example, a Fourier analysis is applied to total kW measurement values, with the kW values (parameter P1) grouped by two different time-of-day ranges (parameter P2), 6 AM to 10 PM in FIG. 9 and 10 PM to 6 AM in FIG. 10. The kW amplitude values captured at each harmonic frequency over the operating range of the power transformer are grouped by harmonic, as shown by the groups 90, 91 and 92 in FIG. 9 for 6 AM to 10 PM, and by the groups 100, 101 and 102 in FIG. 10 for 10 PM to 6 AM. One or more statistical summary parameters (such as mean and standard deviation) may be used to establish expected bounds for the kW values, by harmonic, for each time-of-day range. If Fourier analysis of measured kW values yields amplitude values that fall outside the bounds for any harmonic frequency, for the applicable time-of-day range, the power transformer may not be operating as expected. Note that this approach can be used to track both amplitude and frequency changes in load operation.

Load operation profiles generated using either of the two main approaches outlined above may be further manipulated by a user before being put into use by the system. As an example, a user may observe the kW vs. sub-load profile shown in FIGS. 7 and 8 and remove data points that occurred during a planned RTU maintenance outage.

Notification rules are used to describe conditions under which a notification is sent to one or more recipients. These rules may incorporate a number of factors, including the following:
Send a notification when parameter measurements exceed established load profile bounds
Send a notification when parameter measurements have returned to values within load profile bounds
Send a notification only when parameter measurements exceed or return within load profile bounds for at least some length of time
Send notifications to different recipients (or recipient groups) based on time of date or day of week
Send a notification only when the bounds of multiple load profiles are exceeded

Notification rules may also be used to trigger additional monitoring system actions. As an example, consider a circular buffer continuously gathering 30-second per-phase ampere measurements for an HVAC unit. This buffer uses a fixed amount of memory and may reuse memory in a FIFO (first in, first out) fashion. The buffer may be configured such that, on receipt of a trigger, 10 minutes of pre-trigger measurements and 10 minutes of post-trigger measurements in the buffer are captured and stored for further analysis.

Multiple notification rules may be used for one load profile to indicate the severity of a deviation from expected load operation. For example, one notification may be triggered when parameter measurements exceed one standard deviation away from the mean representing the load profile, and another notification may be triggered when measurements exceed two standard deviations away from the mean.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A method of monitoring the operation of a load in an electrical power distribution system, said method comprising
selecting a parameter representing operation of said load,
determining an expected characteristic of said parameter during normal operation of said load, said expected characteristic defining expected bounds for variations in said parameter as a function of a second parameter during normal operation of said load,
storing said expected characteristic in a computer memory,
measuring actual values of said parameter in said electrical power distribution system,
storing said measured values, and
comparing said measured values of said parameter with said expected characteristic in a computer to detect potential abnormal operation of said load and outputting from said computer the results of said comparison.

2. (canceled)

3. The method of claim 1 in which said expected characteristic of said parameter is a statistical summary or model of multiple measured values of said parameter during normal operation of said load.

4. The method of claim 3 in which said statistical summary or model comprises amplitudes for different harmonic frequencies from a Fourier analysis of measured values of said parameter.

5. The method of claim 3 in which said statistical summary or model comprises a standard deviation from the mean of a set of measured values of said parameter.

6. The method of claim 3 in which said expected characteristic is a statistical summary or model of multiple measured values of a first parameter versus a second parameter that is a driver of the normal operation of said load.

7. The method of claim 6 in which said first parameter is the energy consumption of said load, and said second parameter is the time of day.

8. The method of claim 6 in which said first parameter is the energy consumption of sub-loads within said load, and said second parameter is the type of sub-load.

9. The method of claim 1 which includes generating a notification in response to the detection of potential abnormal operation of said load.

10. The method of claim 1 in which said expected characteristic comprises a normal range of values for said parameter, and said comparing determines whether an actual value of said parameter after termination of a disturbance is within said normal range of values.

11. The method of claim 1 in which said expected characteristic of a parameter representing normal operation of an electrical load is at least one characteristic selected from the group consisting of a parameter trend characterization, harmonic characterization, and a characterization of the typical change in a parameter value following a disturbance.

12. A method of generating a notification of potential abnormal operation of a load in an electrical power distribution system, said method comprising
selecting a parameter representing operation of said load,
determining an expected characteristic of said parameter during normal operation of said load, said expected characteristic defining expected bounds for variations in said parameter as a function of a second parameter during normal operation of said load,
storing said expected characteristic in a computer memory,
measuring actual values of said parameter in said electrical power distribution system,
storing said measured values,
comparing said measured values of said parameter with said expected characteristic in a computer to detect potential abnormal operation of said load, and
generating in said computer a notification of potential abnormal operation of said load in response to the detection of potential abnormal operation of said load.

13. (canceled)

14. The method of claim 12 in which said expected characteristic of said parameter is a statistical summary or model of multiple measured values of said parameter during normal operation of said load.

15. The method of claim 14 in which said statistical summary or model comprises amplitudes for different harmonic frequencies from a Fourier analysis of measured values of said parameter.

16. The method of claim 14 in which said statistical summary or model comprises a standard deviation from the mean of a set of measured values of said parameter.

17. The method of claim 14 in which said expected characteristic is a statistical summary or model of multiple measured values of a first parameter versus a second parameter that is a driver of the normal operation of said load.

18. The method of claim 12 in which said notification is sent to preselected recipients.
